(19) United States
(12) Patent Application Publication
(10) Pub. No.: US 2014/0344704 A1
(43) Pub. Date: Nov. 20, 2014

(54) ELECTRONIC SYSTEM

(71) Applicant: ASUSTeK COMPUTER INC., TAIPEI (TW)

(72) Inventors: Cheng-Yao HUANG, TAIPEI (TW); Ping-Yen TSAI, TAIPEI (TW); Ren-Jiun HUANG, TAIPEI (TW); Hsing-Yu YU, TAIPEI (TW); Chi-Feng YANG, TAIPEI (TW)

(73) Assignee: ASUSTeK COMPUTER INC., TAIPEI (TW)

(21) Appl. No.: 14/272,503

(22) Filed: May 8, 2014

Related U.S. Application Data
(60) Provisional application No. 61/825,107, filed on May 20, 2013.

(30) Foreign Application Priority Data
Apr. 10, 2014 (TW) 103113250

(51) Int. Cl. G06F 15/173

(52) U.S. Cl. CPC G06F 15/17306
USPC 715/740

(57) ABSTRACT

An electronic system is provided. The electronic system includes a first electronic device and a second electronic device. The first electronic device includes a first display unit and a first processing unit. The first processing unit is used to run a first operating system. The second electronic device includes a second processing unit. The second processing unit is used to run a second operating system. The first electronic device and the second electronic device independently run the first operating system and the second operating system. When the first electronic device is electrically connected to the second electronic device, a state of the first operating system and the second operating system are respectively maintained and are selectively displayed on the first display unit.

### CROSS-REFERENCE TO RELATED APPLICATION

This application claims the priority benefit of U.S. provisional application Ser. No. 61/825,107, filed on May 20, 2013 and Taiwan application serial No. 103113250, filed on Apr. 10, 2014. The entirety of the above-mentioned patent application is hereby incorporated by reference herein and made a part of specification.

### BACKGROUND OF THE INVENTION

1. Field of the Invention

The invention relates to an electronic system and, more particularly, to an electronic system with an operating system.

2. Description of the Related Art

Conventionally, a computer usually cooperates with a single operating system. With the development of various kinds of operating systems, a computer with multiple operating systems becomes a basic requirement of users. In a conventional computer with multiple operating systems, different operating systems are installed in a virtual machine, and then it can operate different operating systems in the same device. However, when the user operates one of the operating systems, other operating systems are in power of states or sleeping states. Thus, the user must wait for a few minutes while switching to another operating system. Furthermore, when the user operates one of the operating systems, another operating system cannot be used simultaneously, and thus the efficiency of operating computers with multi operating systems cannot be maximized.

### BRIEF SUMMARY OF THE INVENTION

An electronic system is provided. A user can simultaneously operate different operating systems installed in different electronic devices, and thus resources of different electronic devices can be sufficiently used.

An electronic system including a first electronic device and a second electronic device is provided. The first electronic device includes a first display unit and a first processing unit. The first operating system is used to run the first operating system. The second electronic device includes a second processing unit. The second processing unit is used to run the second operating system. The first electronic device and the second electronic device independently run the first operating system and the second operating system. When the first electronic device is electrically connected to the second electronic device, the state of the first operating system and the second operating system maintain are respectively maintained and are selectively displayed on the first display unit.

An electronic system including at least two electronic devices is provided. Each electronic device includes different operating systems. A user can independently use the operating systems of each electronic device, respectively, and the user also can selectively simultaneously operate different operating systems in the electronic system to sufficiently use all resources of each electronic device, which increases efficiency and flexibility of operating the electronic device.

### BRIEF DESCRIPTION OF THE DRAWINGS

FIG. 1a is a schematic diagram showing an electronic system in the first embodiment;

FIG. 1b is a schematic diagram showing an electronic system in the second embodiment;

FIG. 1c is a schematic diagram showing an electronic system in the third embodiment;

FIG. 2 is a block diagram showing an electronic system in the first embodiment;

FIG. 3 is a block diagram showing an electronic system in the second embodiment; and

FIG. 4 is a schematic diagram showing a display unit simultaneously displays operations at a first operating system and a second operating system in an embodiment.

### DETAILED DESCRIPTION OF THE EMBODIMENTS

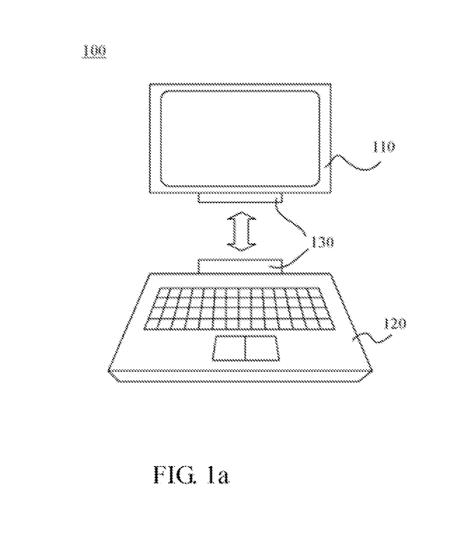

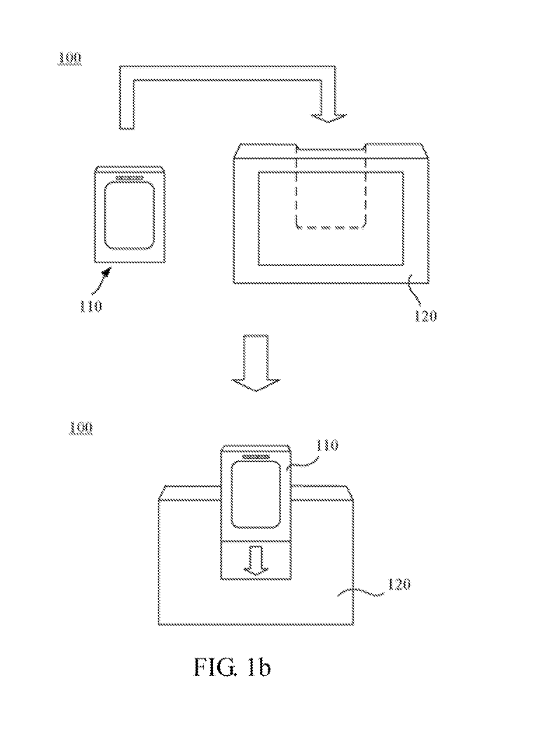

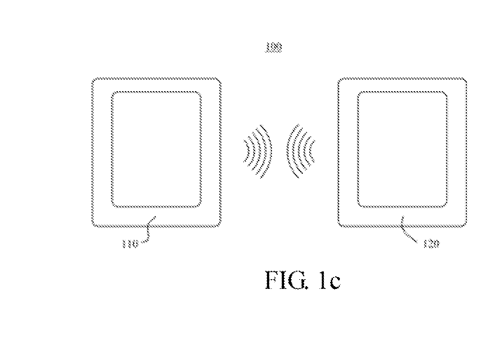

FIG. 1a is a schematic diagram showing an electronic system 100 in the first embodiment. The electronic system 100 includes a first electronic device 110, a second electronic device 120 and a connecting unit 130. Please refer to FIG. 1a, the first electronic device 110 is detachably connected to second electronic device 120 via the connecting unit 130. In other words, when the first electronic device 110 is detached from the second electronic device 120, the first electronic device 110 and the second electronic device 120 can be operated respectively. When the first electronic device 110 is electrically connected to the second electronic device 120, the first electronic device 110 and the second electronic device 120 are integrated to form the electronic system 100.

The first electronic device 110 is connected to the second electronic device 120 wiredly or wirelessly, which is not limited herein.

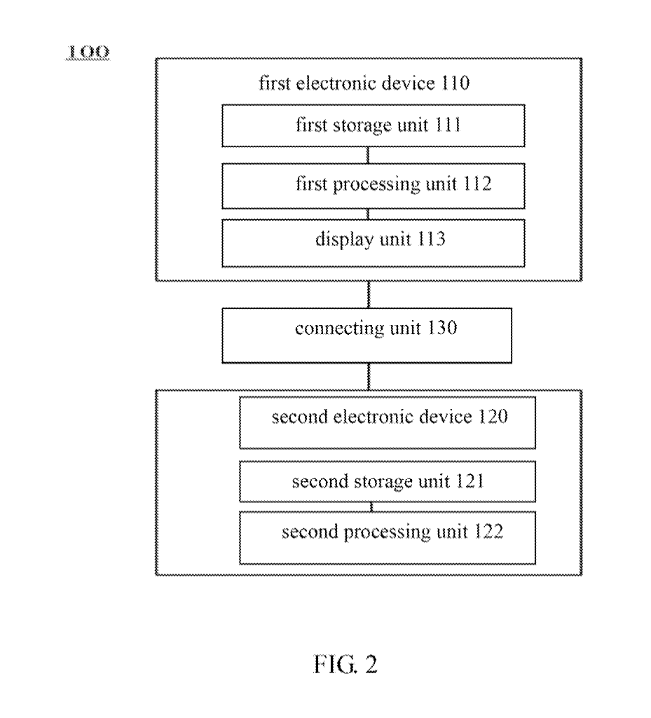

In detail, please refer to FIG. 1a and FIG. 2, FIG. 2 is a block diagram showing an electronic system 100 in the first embodiment. In this embodiment, the first electronic device 110 includes a first storage unit 111, a processing unit 112 and a display unit 113. Furthermore, a first operating system is installed in the first storage unit 111 and the first electronic device 110 runs the first operating system via the first processing unit 112. Similarly, the second electronic device 120 includes a second storage unit 121 and a second processing unit 122. Furthermore, a second operating system is installed in the second storage unit 121 and the second electronic device 120 runs the second operating system via the second processing unit 122, and the first operating system is different from the second operating system.

In an embodiment, the first electronic device 110 may include a compute device with a display panel (such as a tablet computer). The second electronic device 120 may include a computer device with an input device (such as a keyboard or a mouse), which is not limited herein.

For instance, refer to FIG. 1b, FIG. 1b is a schematic diagram showing an electronic system 100 in the second embodiment. In this embodiment, the first electronic device 110 is a mobile phone. The second electronic device 120 may be a computer, such as a tablet computer. A concave portion is formed at a back side of a display screen of the computer, and the size of the concave portion is about same to that of the mobile phone. In other words, the connecting unit 113 may be a concave portion. Thus, the mobile phone is connected to the computer via the concave portion to form the electronic system 100. When the mobile phone is inserted into the concave portion, a display screen of the mobile phone is opposite to as display screen of the computer. Therefore, a user can simultaneously operate the mobile phone and the computer and share mutual resources.

In an embodiment, both of the first electronic device 110 and the second electronic device include a computer device with a display panel. FIG. 1c is a schematic diagram showing an electronic system 100 in the third embodiment in this embodiment, the first electronic device 110 is wirelessly connected to the second electronic device 120 to form the electronic system 100 and shares mutual resources.

In an embodiment, the first operating system and the second operating system can respectively include a Windows operating system, an Android operating system, a Linux operating system, a Mac operating system, a Unix operating system or a Berkeley Software Distribution (BSD) operating system, which is not limited herein.

When the first electronic device 110 is detached from the second electronic device 120, the first electronic device 110 and the second electronic device 120 can respectively run the first operating system (such as an Android operating system) and the second operating system (such as a Windows operating system). Detailedly speaking, when the first electronic device 110 is detached from the second electronic device 120, the first electronic device 110 and the second electronic device 120 are independent computer devices. The user can respectively operate the first operating system via the first electronic device 110 and operate the second operating system via the second electronic device 120.

On the other hand, when the first electronic device 110 is connected to the second electronic device 120 via the connecting unit 130, the user can simultaneously operate the first electronic device 110 and the second electronic device 120. Detailedly speaking, when the first electronic device 110 is electrically connected to the second electronic device 120, the first electronic device 110 and the second electronic device 120 integrate to form the electronic system 100 (such as a notebook), and the first operating system and the second operating system can run simultaneously.

Detailedly speaking, when the first electronic device 110 is electrically connected to the second electronic device 120, the state of the first operating system and the second operating system before first electronic device 110 is electrically connected to the second electronic device 120 are respectively maintained, and the first operating system and the second operating system are selectively displayed on the display unit 113.

Detailedly speaking, when the first electronic device 110 is electrically connected to the second electronic device 120, there may be three cases. In the first case, the first operating system and the second operating system are running simultaneously and one of the operating systems is displayed on the display unit 113. In the second case, the first operating system is running and the second operating system is turned off, and the first operating system is displayed on the display unit 113. In the third case, the first operating system is turned off and the second operating system is running, and the second operating system is displayed on the display unit 113.

When one of the first operating system and the second operating system is selected, the selected running operating system is displayed on the display unit 113. Furthermore, when the first operating system or the second operating system is running, the first processing unit 112 and the second processing unit 122 can selectively access data of the first storage unit 111 and the second storage unit 121. In other words, when the display unit 113 displays the first operating system, the user can operates the first operating system and access data of the first storage unit 111 and/or the second storage unit 121 via the first processing unit 112. When the display unit 113 displays the second operating system, the user can operate the second operating system and access data of the first storage unit 111 and/or the second storage unit 121 via the second processing unit 122.

Furthermore, when one of the operating systems is operated and the operating system is displayed on the display unit 113, the other operating system can run in the background simultaneously. For instance, the user can deal with documents via Office of the Windows operating system and simultaneously download data via the Android operating system, or the user can play games via the Android operating system and simultaneously scan by the antivirus software of the Windows operating system.

In an embodiment, the first storage unit 111 and the second storage unit 121 may include one or a combination of a random access memory, a non-volatile memory, a hard disk, a USB driver, a database which can accessed by network, or a readable memory, which is not limited herein. The first processing unit 112 and the second processing unit 122 may include a central processing unit (CPU), an advanced RISC machines (ARM) processor, or a microprocessor without interlocked piped stages (MIPS) processor, which is not limited herein.

On the other hand, when the first operating system or the second operating system is running via the electronic system 100, data of the first storage unit 111 and the second storage unit 121 can simultaneously be accessed, relating resources of the first electronic device 110 and the second electronic device 120 can be used at the same time.

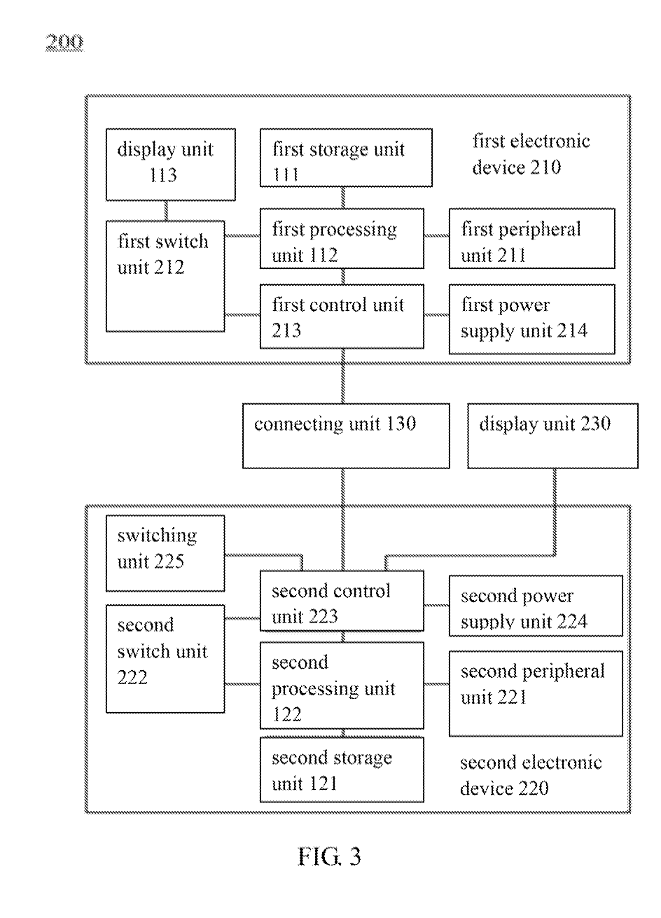

FIG. 3 is a block diagram showing an electronic system in the second embodiment. In this embodiment, the first electronic device 210 further includes a first peripheral unit 211, a first switch unit 212, a first control unit 213 and a first power supply unit 213. The second electronic device 220 further includes a second peripheral unit 221, a second switch unit 222, a second control unit 223 and a second power supply unit 224. In an embodiment, the first peripheral unit 211 and the second peripheral unit 224 are electrically connected to the first processing unit 112 and the second processing unit 222, respectively. The first switch unit 212 is electrically connected to the first processing unit 112, the display unit 113 and the first control unit 213. The second switch unit 222 is electrically connected to the second processing unit 122 and the second control unit 223. The first control unit 213 is electrically connected to the second control unit 223 via the connecting unit 130.

In an embodiment, the first peripheral unit 211 and the second peripheral unit 221 include at least one of an input device (such as a keyboard or a mouse), an output device (such as a video camera, a headset, a loudspeaker or a microphone), a CD-ROM driver, a wired/wireless network device, an input/output connector (such as a USB interface, a HDMI interface or an audio interface), which is not limited herein.

In an embodiment, when the first electronic device 210 is electrically connected to the second electronic device 220, the first operating system and the second operating system are running via the first electronic device 210 and the second electronic device 220 respectively and make the running operating system displayed on the display unit 113. The operating system displayed on the display unit 113 has a control right of the first peripheral unit 211 and the second peripheral unit 221. In other words, when one of the first operating system or the second operating system is running, the use resources of the peripheral unit 211 and the second peripheral unit 221 can be used simultaneously.

Detailedly speaking, when the first electronic device 210 is electrically connected to the second electronic device 220, the first control unit 213 can obtain resource information of the second electronic device 220 via the connecting unit 130. Similarly, the second control unit 223 also can obtain resource information of the first electronic device 210 via the connecting unit 130. Then, the first control unit 213 and the second control unit 223 determine which electronic device has a right control of the display unit 113. Furthermore, the electronic device which has the control right of the display unit 113 simultaneously has a control right of the resources of the other electronic device.

In an embodiment, when the first electronic device 210 is connected to the second electronic device 220 for the first time, the first electronic device 210 has the priority of the control right of the display unit 113. Detailedly speaking, the first electronic device 210 make the information processed by the first processing unit 112 displayed on the display unit 113 via the first control unit 213 (that is the first operating system is displayed on the display unit 113). Similarly, the second processing unit 122 is executed in the background. Furthermore, the second processing unit 122 provides a control right of the second peripheral unit 221 to the first processing unit 112 via the second control unit 223. In other words, when the user operates the first operating system via the display unit 113, the user can simultaneously use peripheral resources (such as a keyboard, a mouse, a network interface) of the second electronic device 220.

For instance, the first peripheral unit 211 includes a video camera and the second peripheral unit 221 includes a USB interface. When the user operates the first operating system (such as an Android operating system) via the display unit 113 (that is, the first electronic device 210 has the control right of the display unit 113), the user can simultaneously use the USB interface of the second electronic device 220 to connect to a USB flash drive. When the user operates the second operating system such as a Windows operating system), the user can simultaneously user the video camera of the first electronic device 110 to communicate. Thus, peripheral resources in the first electronic device 110 and the second electronic device 120 can be fully used. Furthermore, external input/output devices for the first operating system and the second operating system can be increased via the input/output interface to increase flexibility and efficiency of using the electronic system 200.

When the first electronic device 210 is detached from the second electronic device 220, the first control unit 213 is not connected to the second control unit 223 via the connecting unit 130, and thus the first control unit 213 and the second control unit 224 cannot access mutual resources information via the connecting unit 130. At the moment, the first control unit 213 and the second control unit switch the control right of the hardware resources of each device to the first processing unit 112 and the second processing unit 122, respectively. For instance, when the second electronic device 220 has the control right of the display unit 113 (that is, the display unit 113 displays the second operating system), when the first electronic device 210 is detached from the second electronic device 220, the control right of the display unit 113 is immediately switched to the first electronic device 210.

On the other hand, when the user is operating the first operating system or the second operating system and wants to switch to use another operating system, the user can control the first switch unit 212 and the second switch unit 222 to achieve the switch effect.

In an embodiment, when the first electronic device 210 is connected to the second electronic device 220 and the first switch unit 212 and the second switch are both turned on, the first control unit 213 or the second control unit 222 determines which device (such as the first electronic device 210) has the control right of the display unit 113 and peripheral units of the other device according to the switch unit which is first turned on, and the device corresponding to the switch unit which is second turned on (such as the second switch unit 222) runs in the background.

When one (such as the first switch unit 212) of the first switch unit 212 and the second switch unit 222 is turned off, the display unit 113 switches from the operating system (such as the first operating system) corresponding to the switch unit which is turned off to the operating system (such as the second operating system) corresponding to the switch unit which is currently turned on.

Detailedly speaking, when the first electronic device 210 has the control right of the display unit 113 and the first switch unit 212 is turned off, the first control unit 213 provides a switch command to the second control unit 223, the second control unit 223 obtains the control right of the first peripheral unit 211 and the display unit 113. Similarly, when the second switch unit 222 is turned off, the second electronic device 220 gives the control right of the second peripheral unit 221 and the display unit 113 to the first electronic device 210.

Detailedly speaking, when the first electronic device 210 is connected to the second electronic device 220, when the first switch unit 212 is first turned on, the control unit 213 and the second control unit 223 can detect that the first switch unit 212 is turned on, at the moment, the first control unit 213 controls the first processing unit 112 to obtain the control right of the display unit 113, the first peripheral unit 211 and the second peripheral unit 221 and makes the first operating system displayed on the display unit 113. Thus, the user can operate the first operating system on the display unit 113 and simultaneously use resources of the first peripheral unit 211 and the second peripheral unit 221.

Then, when the first switch unit is still in a turned on state and the second switch unit 222 is also turned on, the first control unit 213 and the second control unit 224 can detect that the first switch unit 212 and the second switch unit 222 are both turned on, and thus the second control unit 223 would not obtain the control right of the display unit 113, the first peripheral unit 211 and the second peripheral unit 221. If the first switch unit 212 is turned off at the moment, the first control unit 213 and the second control unit 223 detect that only the second switch unit 222 is turned on, the second control unit 223 controls the second processing unit 122 to obtain the control right of the display unit 113, the first peripheral unit 211 and the second peripheral unit 211 and makes the second operating system displayed on the display unit 113.

In an embodiment, the electronic system 200 further includes a switching unit 225. The switching unit 225 may be connected to the first control unit 213 or the second control unit 223, and it is used to switch the control right of the display unit 113. In this embodiment, the switching unit 225 is disposed in the second electronic device 220 and electrically connected to second control unit 223, which is not limited herein, in other words, the switching unit 225 may also be disposed in the first electronic device 210, or it is achieved via a remote control way.

In this embodiment, when the switching unit 225 is enabled, the switching unit 225 generates a switching signal to the first control unit 213 and the second control unit 223. The first control unit 213 and the second control unit 223 switch the first operating system displayed on the display unit 113 to the second operating system or switch the second operating system displayed on the display unit 113 to the first operating system according to the switch signal.

Detailedly speaking, if the first electronic device 210 has the control right of the display unit 113 (that is the display unit 113 displays the first operating system at the moment), when the switching unit 225 is enabled, the second control unit 223 outputs a switch demand to the first control unit 213 to make information processed by the second processing unit 122 displayed on the display unit 113 (that is, the display unit 113 displays the second operating unit at the moment). Furthermore, the second control unit 223 gives the control right of the first peripheral unit 211 and the second peripheral unit 221 for the second processing unit 122.

Similarly, when the second electronic device 220 has the control right of the display unit 113, and the switching unit 225 is enabled, the operating mode is switched similar to above, which is omitted herein.

In an embodiment, the first switch unit 212, the second switch unit 222 and the switching unit 225 may be physical keys, virtual keys, or they are controlled via a remote control way, which is not limited herein.

On the other hand, except for that resources of the first storage unit 111, the second storage unit 121, the first peripheral unit 211 and the second peripheral unit 221, the first power supply unit 214 and the second power supply also can be shared, the first power supply unit 214 and the second power supply 224 selectively provide electric power for the first electronic device 210 and the second electronic device 220, respectively.

In an embodiment, when the first electronic device 210 is connected to the second electronic device 220, the first control unit 213 and the second control unit 223 can exchange the power state of each power supply unit, external charge capacity, current system state, system consumption, and user state and so on. Then, the first control unit 213 and the second control unit 223 can coordinate the power distribution of the first electronic device 210 and the second electronic device 220, which makes the electronic system 200 operated in one of the following five modes. The five modes is “the first power supply 214 provides electric power for the electronic system 200”, “the second power supply 224 provides electric power for the electronic system 200”, “the first power supply unit 214 charges the second power supply unit 224”, “the second power supply unit 224 charges the first power supply unit 214”, “the first power supply unit 214 and the second power supply unit 224 independently charge corresponding devices, respectively”.

For instance, when the first electronic device 210 is connected to the second electronic device 220, if the second power supply unit 224 can provide larger power than the first power supply unit 214, when electric power stored in the second power supply unit 224 is greater than a threshold value, the second power supply unit 224 provides electric power for the first electronic device 210 and the second electronic device 220 or charges the first power supply unit 214. Furthermore, when the first electronic device 210 is detached from the second electronic device 220, the first power supply unit 214 and the second power supply unit 224 independently provide electric power for the first electronic device 210 and the second electronic device 220, respectively, which is not limited herein. In other words, persons have ordinary skills in the art can have various modes to achieve the effect of sharing electric power of the first power supply unit 214 and the second power supply unit 224 for the electronic system 200.

On the other hand, in an embodiment, the electronic system 200 further includes another display unit 230. The display unit 230 is detachably connected to the second electronic device 220. When the second electronic device 220 is connected to the display unit 230, the second processing unit 122 has a prior control right of the display unit 230. For instance, when the first electronic device 210 is connected to the second electronic device 220, and when the display unit 113 displays the first operating system in running, the display unit 230 can simultaneously display the second operating system which is running. For instance, when the user operates the first operating system (such as an Android operating system) via the display unit 113, another user also can operate the second operating system (such as a Windows operating system) via the display unit 230.

In another embodiment, when the display unit 113 displays the second operating system the user can operate the second operating system to edit documents via the second electronic device 220, and video files of the first operating system (such as an Android operating system) are transferred to the display unit 230 to play. Thus multiple users can use the electronic system 200 together.

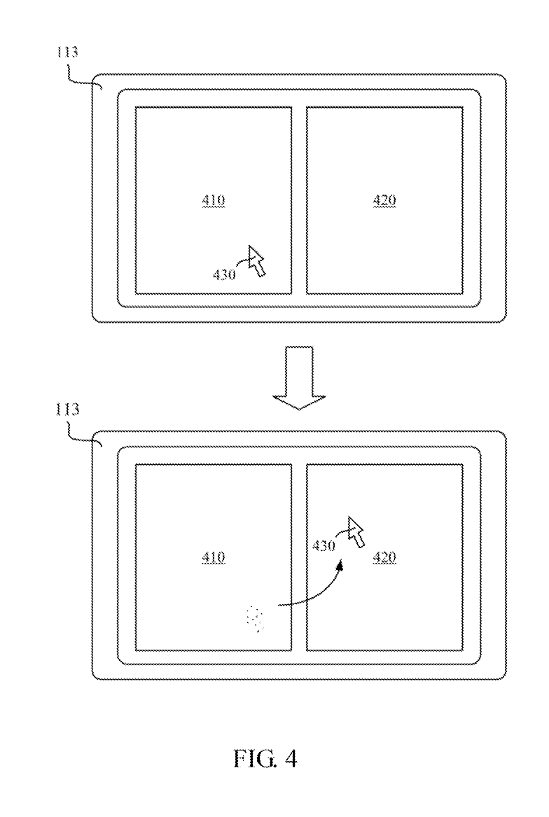

In above embodiments, the display unit is used to display a single operating system which is running, which is not limited herein. In other words, the display unit can simultaneously display the first operating system and the second operating system. FIG. 4 is a schematic diagram showing an operation of a display unit 113 simultaneously displays a first operating system and a second operating system in an embodiment. Referring to FIG. 4, a display image of the display unit 113 can be divided into a first display image 410 and a second display image 420. The first display image 410 and the second display image 420 can simultaneously display the first operating system and the second operating system, respectively.

Further, the user can set the position and size (that is coordinates of the first display image 410 in the display unit 113) of the first operating system in the first display image 410 via the first operating system, and the user can set the position and the size (that is coordinates of the second display image 420 in the display unit 113) of the second operating system in the second display image 420 via the second operating system. Thus, a cursor 430 (or a touch signal) is detected in the coordinates of the first display image 410 or the second display image 420, a corresponding operating system generates a control signal to the first control unit 213 and the second control unit 223 to obtain the control right of the first peripheral unit 211 and the second peripheral unit 221.

For instance, when the user is operating the first operating system, the cursor 430 is located in the coordinates of the first display image 410, the first operating system has the control right of the first peripheral unit 211 and the second peripheral unit 221. When the user moves the cursor 430 to the coordinates of the second display image 420, it represents that the user wants to switch to operate the second operating system, at the moment, the second operating system detects the cursor 430 is in the second display image 420 and transmits a control signal to the first control unit 213 and the second control unit 223, the second control unit 223 controls the second processing unit 122 to obtain the control right of the first peripheral unit 211 and the second peripheral unit 221 according to the control signal. Thus, the user can simultaneously operate the first operating system and the second operating system via the electronic system 200. Furthermore, since the first operating system and the second operating system is simultaneously running, when one operating system is switched to the other one, the user need not to restart the other operating system, which increases the efficiency of using different operating systems.

As stated above, a user can simultaneously operate different operating systems of different electronic devices in an electronic system and use all resources of the electronic system, which increases the efficiency of operating electronic system. The operating system of each electronic device is independently used, which increases the flexibility of operating electronic system. Furthermore, a switch unit and a switching unit are disposed, which can fast switch to different operating systems and improve operation efficiency. Since resources of different devices can be used at the same time, the efficiency of the electronic system can be maximized by expanding other display panels or peripheral resources

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic system, comprising:
a first electronic device including a first display unit and a first processing unit, wherein the first processing unit runs a first operating system; and
a second electronic device including a second processing unit, wherein the second processing unit runs a second operating system;
wherein the first electronic device runs the first operating system and the second electronic device runs the second operating system independently, when the first electronic device is electrically connected to the second electronic device, a state of the first operating system and the second operating system are respectively maintained and are selectively displayed on the first display unit.

2. The electronic system according to claim 1, wherein the first electronic device further includes a first storage unit electrically connected to the first processing unit, the second electronic device further includes a second storage unit electrically connected to the second processing unit, the first operating system is installed in the first storage unit and the second operating system is installed in the second storage unit, respectively, when the first electronic device is electrically connected to the second electronic device, the first processing unit and the second processing unit selectively access data of the first storage unit and the second storage unit.

3. The electronic system according to claim 1, wherein the first electronic device includes a first peripheral unit, and the second electronic device includes a second peripheral unit, respectively, the first peripheral unit is electrically connected to the first processing unit, the second peripheral unit is electrically connected to the second processing unit, when the first display unit displays the first operating system which is running, the first operating system which is running has a control right of the first peripheral unit and the second peripheral unit, when the first display unit displays the second operating system which is running, the second operating system which is running has the control right of the first peripheral unit and the second peripheral unit.

4. The electronic system to claim 1, wherein the first electronic device further includes a first control unit and the second electronic device further includes a second control unit, the first control unit is electrically connected to the first processing unit and the second control unit is electrically connected to the second processing unit, respectively.

5. The electronic system according to claim 4, wherein the electronic system further includes a switching unit, the switching unit is electrically connected to at least one of the first control unit and the second control unit, when the switching unit is enabled, the switching unit generates a switching signal, the first control unit and the second control unit switch the running first operating system displayed on the first display unit to the running second operating system or switch the running second operating system displayed on the first display unit to the running first operating system according to the switching signal.

6. The electronic system according to claim 4, wherein the first electronic device further includes a first switch unit, the second electronic device further includes a second switch unit, the first switch unit is electrically connected to the first display unit, the first control unit and the first processing unit, the second switch unit is electrically connected to the second control unit and the second processing unit, when the first switch unit and the second switch unit is turned on, the first control unit and the second control unit make a corresponding operating system displayed on the first display unit according to which switch unit of the first switch unit and the second switch unit is beforehand turned on and make a corresponding operating system runs in the background according to which switch unit of the first switch unit and the second switch unit is afterward turned on.

7. The electronic system according to claim 1, wherein the electronic system further includes a second display unit detachably electrically connected to the second electronic device, when the first electronic device is electrically connected to the second electronic device and the second display unit is electrically connected to the second electronic device, the first operating system which is in running is displayed on the first display unit and the second operating system which is in running is displayed on the second display unit.

8. The electronic system according to claim 1, wherein the first operating system and the second operating system are simultaneously displayed on the first display unit.

9. The electronic system according to claim 8, wherein the first electronic device further includes a first peripheral unit and the second electronic device further includes a second peripheral unit, respectively, when a cursor is located in a first display image, the first operating system has a control right of the first peripheral unit and the second peripheral unit, when the cursor is located in a second display image, the second operating system has the control right of the first peripheral unit and the second peripheral unit.

10. The electronic system according to claim 1, wherein the first electronic device further includes a first power supply unit, the second electronic device further includes a second power supply unit, when the first electronic device is electrically connected to the second electronic device, the first power supply unit and the second power supply unit selectively provide electric power to the first electronic device and the second electronic device.

11. The electronic system according to claim 10, wherein when the first electronic device is electrically connected to the second electronic device and quantity of the second power supply unit is greater than a threshold value, the second power supply unit provides electric power for the first electronic device and the second electronic device.
